(19) United States
(12) Patent Application Publication
(10) Pub. No.: US 2017/0116672 A1
(43) Pub. Date: Apr. 27, 2017

(54) SYSTEM FOR DETERMINING, AUTOMATING, AND EXECUTING FINANCIAL PURCHASE ORDERS BY COMPARING FINANCIAL ASSETS ASSOCIATED WITH DESIGNATED INVESTORS AND FINANCIAL ASSETS OF DESIGNATING USERS

(71) Applicant: Chia-Ching Chen, Guangzhou City (CN)

(72) Inventor: Chia-Ching Chen, Guangzhou City (CN)

(21) Appl. No.: 15/295,086

(22) Filed: Oct. 17, 2016

Related U.S. Application Data
(60) Provisional application No. 62/246,216, filed on Oct. 26, 2015.

(51) Int. Cl. G06Q 40/06; G06Q 20/22

(52) U.S. Cl. CPC G06Q 40/06; G06Q 20/227

(57) ABSTRACT

A system for forming leader user accounts by analyzing investment activity, receiving user designations of leader user accounts to link financial account behavior, and executing financial purchase orders based on the linkages between active leader users and the following users.

### PRIORITY

This application claims priority to U.S. Provisional Application Ser. No. 62/246216, filed Oct. 26, 2015. The above references application is incorporated herein by reference as if restated in full.

### BACKGROUND

Non-professional investors now have access to and are increasingly taking advantage of online brokerage marketplaces for trading purposes. Simultaneously, these non-professional investors are showing signs that they want greater independence and control over their investment choices. They may still want guidance from professionals, but they want greater control over what professionals they rely on and to what degree they rely on them. However, there is only limited and imperfect development of platforms that provide certain forms of independence and control. The present platform is designed to proide just such independence and control to the user.

### SUMMARY

1. The Platform

In one aspect, software couples a set of algorithms to a user interface. This coupling may embody a platform accessible to users as an internet website or as an application having internet access. The platform may be formatted separately for the various mobile devices, such as smart phones, tablets, etc., as well as the desktop or laptop computer.

2. User Accounts

In one aspect, the platform provides for the creation of user accounts and the storing of user account information in a user account database.

In one embodiment of this aspect, the platform provides for adding one or more articles of user information to the user account database. The platform may provide a user interface enabling a user to sign up for a user account by sending one or more articles of information to the platform, such as the user's first and last name, a user name, a password, one or more security questions and/or answers to those security questions, geographical information such as country, state, city, zip code, and address, social security number or other governmental identification numbers or codes, citizenship and/or residency status, age, as well as other articles of information that are conceivably relevant to the setting up of a user account. The platform may add a user account to the user account database, and associate these articles of information with that user account.

In another embodiment of this aspect, the platform provides a user interface enabling the user to verify one or more of the above articles of information by means of scanning, photographing, or otherwise digitally capturing and uploading physical or physically derived identification materials to the platform. The platform may then process these identification materials in order to extract articles of information. Such verification of one or more articles of information may be necessary before the platform associates those articles of information with a given user account, or even before a user account may be created and stored in the user account database at all.

In yet another embodiment of this aspect, the platform provides a user interface enabling the user to indicate one or more third party sources, such as websites, financial accounts, and/or government databases to provide one or more articles of information. The user may enter or select the third party ID, such as the URL of a site hosted by a third party source, an identifying number (such as a routing number), or even simply the name of the third party source, such that the user sends and the platform receives that third party ID. Selection may occur by means of a drop down menu or list located on the platform.

The platform may engage with the API or user interface of the third party source to access, record, or execute changes to data stored on databases operated by that third party. Accordingly, the API or user interface may act as a mediary for these actions. Engagement may be initiated by the user, the operators of the platform, or as a result of platform processing. Such engagements by the platform may be actuated by sending to the third party API or user interface one or more articles of information. These articles of information may include, for example, the username, password, or related identification information provided when engagement is initiated, either by the user sending those articles of information in response to a prompt, or by calling the articles of information stored in the database once engagement is initiated.

The user may initiate engagement between the platform and a particular third party source by entering or selecting the third party ID associated with that third party.

The platform may receive one or more articles of information from a third party source, modify or format it to fit the platform's protocol, associate it with the user's user account, and store it in the user account database.

3. Financial Accounts

In one aspect, the platform may associate one or more financial accounts and/or articles of information relating to those one or more financial accounts with a user account. This association occurs when the user sends and the platform receives articles of information relating to the financial account. In one version, the user provides the routing number and account number relating to the financial account. The platform may access, track, and affect changes on the financial account as a result of associating it with the user account.

In one embodiment, the platform may provide a user interface allowing a user to view representations of the set of financial accounts associated with that user's user account displayed in a “financial account” list. The financial accounts may be represented in list form, tile form, or any other manner in which each account is identified. Information displayed adjacent to or connected to each financial account representation may include the name of the bank or financial institute in which the financial account resides, the account and/or routing number, the to-date balance, a detailed list of a fixed number of recent transactions, a user-defined name assigned by the user through a user interface feature to identify the account to himself or herself, and/or a group or category in which the financial account falls under. These groups or categories may signify investment strategies that have been assigned by the user to the account, or any other useful heuristic for the user to determine the purpose of the financial account in terms of his or her investment strategy. From hereon, the application will cease distinguishing between “representation of a financial accounts” and “financial accounts”, since it should be clear based on the context which is being referred to.

In one version, the platform displays and the user can view in the financial accounts list “virtual” financial accounts, which are related to actual financial accounts, except that they do not affect actual money; rather, a virtual account displays how a given financial account would be affected if it were to hypothetically mimic one or more transactions executed in one or more financial accounts associated with leaders that are followed by the user. This will be explained in greater detail below.

In one version, virtual financial accounts may be displayed in the same “tab” or area of the user interface in which the actual financial accounts are displayed. In another version, virtual financial accounts are displayed in a separate area or tab from that which displays the actual financial accounts. In yet another version, a user interface artifact may be selected or engaged with by the user, causing one or more virtual financial accounts to be displayed adjacent to the representation of an actual financial account.

In one aspect, the financial account referred to herein may be derived from a bank or brokerage account separate from the platform, or may be a brokerage account operated principally by the operators of this platforms. Such a financial account may be referred to as a “native” financial account.

4. User Profiles

In one aspect, a user account comprises a user profile. The user profile is the display in the user interface of one or more articles of information associated with the user account, as well as a source of functionality provided to the users of the platform. This functionality has already been discussed in part, in so far as it relates to the financial accounts list, but it also provides many other engageable actions to the users.

In one embodiment, the user profile may be modified by the user in regard to what content is displayed, such as name, picture, text, etc. In one version, the user may modify the layout of the content by selecting or modifying a template provided by the platform. Such modification may be actuated by drag and drop actions operating on one or more user interface artifacts. In another version, the user may upload content in the form of videos, powerpoint slides, or other mediums of content presentation. The uploading may be facilitated by an appropriate user interface artifact such that, when selected, a prompt is displayed, that prompt featuring a file location field which allows the user to navigate his or her own file systems to select the file to be uploaded. In yet a another version, the set of articles of information and/or layout of those articles depend on the type of user account, e.g., regular user or leader, both of which will be explained and distinguished below.

In one embodiment, the user may select what articles of information are visible and to whom, and/or what are hidden and to whom. In one version, the platformprovides visibility settings for each article of information, by means of a pull down menu displayed on or adjacent to the article of information, or by the selection of one or more graphical icons that represent given privacy settings. In yet another version, the user can identify the privacy setting of a given article of information in regard to one or more other user accounts, or categories of user accounts, such that a given article of information may be only viewed by user accounts that the user “follows” (to be explained later), but may not be available to user accounts generally; or it may be visible to one user account but not to another user account. This individuated or group-focused privacy setting modification may be enabled by a user interface artifact localized on or adjacent to the article of information, as described above, localized on a relevant user account's profile (as viewed and interacted upon by the user desiring to effect privacy control), or centralized in a general “settings” section, albeit further featuring either a search field in which a username may be entered. Note that in the preceding and following paragraphs, “articles of information” and “content” are terms that may be used and understood interchangeably.

5. Performance History

In another aspect, a user account may comprise a performance history. A performance history comprises a set of data that may be grabbed from one or more financial accounts and/or obtained by tracking transactions executed by or through those financial accounts. The set of data may be provided by one or more native financial institutions or obtained by the platform itself.

The data relevant for the performance history depends on the investment class. For bonds, the relevant data includes the date of purchase and the purchase price, the rate of return, coupons, and the redemption date. For stocks, the relevant data includes the date of purchase, purchase price, the number of shares purchased, the date and quantity of dividends, the sale price, and the amount sold. For mutual funds, the relevant data includes the management fee as well as any data relevant to stocks and bonds. There may also be data specific to shortselling, such as borrow cost, and other investment methods, such as those for currency exchange.

In one embodiment, the performance history data is analyzed by the platform so that relationships between one or more parameters are computed, stored in the user account database, and updated as additional transactions are executed and analyzed. Some of these parameters include time, a monetary amount, a species of security, a genus of security, industry category, as well as other basic parameters. Computations may include the change of monetary amount for a species of security over time, the percentile relationship over time between an initial amount invested and the price times the quantity of a given stock and/or the dividends received as well as other relevant computations. More holistic parameters may include total account value, calculated as quantity x price. Performance History metrics may use the money weight rate of return method, in which a discount rate is applied to all inflows and outflows such that the inflows equal the outflows. However, since this method is very sensitive to withdrawals that may be outside the investors control, Performance History metrics may use the time weight rate of return, in which the difference between the final and initial market value, added to the interest or dividends, subtracted by the cash flow difference, is compared to the initial market value. These values are determined per time period of significant withdrawal and deposit, and compounded.

In another embodiment, the performance history comprises a graphical display featured on a user profile (although it may also be featured on an index profile, which will be discussed). In one version of this embodiment, the display features a range of dates on one axis and a number range on another axis. The number range may include percentiles, standard deviations from zero, or absolute numbers, and may correspond to monetary amounts, a number of securities, or price points. The display may feature a selection-based user interface artifact for selecting the unit and or metric of the one or more axes, and/or the security type, industry category, or specific security species that is being measured. In a further version, the user may select a second set of data to compare to the first set of data, or the same set of data represented by a different set of parameters; these data sets may be compared by superimposing one over the other, such that either one or both are partially transparent, adjacent, and/or overlapping. In an additional version, the user may zoom in and out of a given axis by means of artifacts in the user interface or by manipulations on the hardware that is being used to interact with the platform, such as a mouse or keyboard.

6. Leaders and Indexes

In one aspect, the performance history is analyzed based on a set of metrics, such as number of transactions, monetary amount of transactions, category of transactions, frequency of transactions, date range of transactions, rate of transactions resulting in gains. and/or transaction profit. The platform may calculate one or more of these metrics using a propietary equation, which may involve comparing an output derived from one or more metrics with a number or set of numbers (“standards set”) identified by the operators of the platform, such that a set of data from a given user account “passes” or “fails” in the comparison, by exceeding or not exceeding the standards set. In one embodiment, user accounts associated with a performance history that “pass” one or more metrics are entitled to be categorized and treated by the platform as “leader” user accounts. In another embodiment, users may pay to have their accounts upgraded to “leader” accounts. In yet another embodiment, a set of leader user accounts may be selected by the platform, by the operators of the platform, and/or by other means, and treated collectively as an index. The set may include all leader user accounts or a portion thereof. The portion may be limited to a set of the leader user accounts that pass the one or more metrics by at least a certain margin, or that pass the one or more metrics by at least a certain margin above another portion of the set of leader user accounts, or discretionarily determined by the operator. Alternatively or additionally, the portion may comprise a set number of the accounts, e.g., “100” that have most exceeded the standards set. In yet another embodiment, the set of all leader user accounts may be divided into seperate, perhaps overlapping, industry categories. In an additional embodiment, the set of all leader user accounts may be the common set shared by two seperate sets, such as leaders within a given industry and leaders that are in a top tier of accounts (top 100). In a yet additional embodiment, the set of all leader user accounts may be limited sequentially—for example, those that fall within a given industry, and the top 100 within that given industry. Each portion/set may comprise its own index.

In one embodiment, leaders comprising an index may be unequally “weighed” in the index. The transactions of a leader that is assigned more weight than another leader may be treated as if they were a percentage greater than they actually are. For example, if a highly weighed leader purchases x shares, the index will be considered to have purchased x times a number greater than 1, wherein that number is associated or calculated from the weight assigned to that leader.

In one embodiment, the weight assigned to a leader may be based on that leader's performance history, or based on the leader's perfomance history compared to the performance histories of other leaders in the index.

In another embodiment, the weight may be based on how the leader is classified, either by the operators of the platform or by the platform itself, based on a set of metrics. For example, the platform may determine that a given leader is conservative in the leader's investment practices or history, and therefore may assigned a greater weight than that assigned to a less conservative leader.

In another embodiment, the weight may be based on whether the classification assigned to a given leader matches the classification of a given index. For example, if a given index is identified or determined to be a high risk index, then a leader identified or determined to be high-risk oriented in the leader's practices or history will be assigned a greater weight.

In yet another embodiment, the weight may be based on the classification of other leaders in an index. For example, if many or even most of the leaders in a given index are identified or determined to be conservative, then a high-risk oriented leader may be given a greater weight in order to balance the risk profile of the index.

In yet another embodiment, the weight may be assigned to a leader based on a set of weights, such that a leader identified as first in a given metric is assigned the first weight, and a leader identified as second is assigned the second weight, etc.

If a leader is removed from an index, then the weights of each leader in the index may be recalculated.

In another embodiment, the platform allows a user to create their own index. The user interface may provide a set of fields and/or drop down menus, enabling the user to select or enter one or more industries and/or security types, and/or a percentile and/or fixed number of leaders who have most exceeded the standards set. In one version of this embodiment, this user-defined index may be shared publically or semi-publically so as to permit other users to follow it. The user may add one or more of the user's created indexes to the user's profile or send to one or more other users in the form of the parameters selected, a graphical representation of one or more parameters relating to the performance history of the index, and/or representations of an index profile (to be explained below). In another version, the user-defined index is kept private to the user.

In one aspect, an index may comprise its own user profile and user account, called an index profile or an index account. The index profile may be created manually by the operators of the platform using the user interface or visible side of the platform, or automatically by virtue of calculations and actions executed by the platform. In one embodiment, only the operators of the platform have access to the customization related actions of the index profile. In another embodiment, if a user creates an index, that user can customize the index profile.

In one embodiment, the index account may be associated with any of the financial accounts associated with the leader accounts that comprise an index.

7. View List

In one aspect, the user account comprises a “view list”. This view list comprises a set of one or more user profiles that a given user has added to the view list. This “adding” is essentially a user interface artifact that may be selected by the user, thereby indicating to the platform that the user intends that the added user profile be represented in a list with other added user profiles. Thereafter, when the user accesses the user's view list, the user can see representations of user profiles. The representations of the profiles feature a set of the articles of information that may be displayed on those profiles; either the representations or some part thereof may be selected by the user, causing the targeted user profile to be displayed in full. Adding a user profile to a view list may also provide functionality to the added user account; the user of the added user account may in turn view one or more components on the adding user's profile.

In one embodiment of this aspect, the user can add or delete one or more user profiles to the view list associated with that user's user account; the platform receives a signal from the user interface that one or more user accounts are added or deleted, and adds or deletes the corresponding user account. In one version, if a first user account is added or deleted from a second user account's view list, then the second user account is automatically added or deleted from the first user account's view list. For convention's sake, a user account refers to an underlying set of data and options associated with that data and functionality provided to the user in regard to the platform, whereas the profile is merely the representation of the account. Still, it must be understood that as the terms are so closely linked, they may be used interchangeably.

In another embodiment, before a user profile is added to a view list, the user of that added user profile must first approve the action. Adding a user profile to a view list sends a request to the added user. In one version, there is a notification section of the user interface which alerts the user that a request has been received. This request can be approved or rejected. If an approval is received by the platform, then the platform adds the user profile to the view list.

8. Leader List

In another aspect, the user account comprises a “follow list”. Basically, the follow list is similar to any or all of the embodiments of the “view list” described above. In one embodiment, a user may only follow another user account if that user account is categorized as a leader user account. In another embodiment, a user may follow an index account.

9. Transactional Linking

When a user follows an account, one or more of the user's financial accounts are “transactionally linked” with one or more of the followed account's financial accounts. When a first financial account is transactionally linked to a second financial account, the platform will execute transactions in or through the first financial account in response to transactions executed in or through the second fnancial account. For example, if the second financial account buys a given quantity and type of stock, the platform will execute a purchase aproportion of that quantity and type of stock in or through the first financial account based on a pre-established metric, such as comparing the size of the second financial account to the size of the first financial account

The user may select one or more of the one or more financial accounts associated with that user's user account to transactionally link to a followed account's financial accounts. In another version, the user may transactionally link a financial account to at least one, but not all of a followed account's financial accounts. In another version, the user may transactionally link only a portion of a financial account. This portion may constitute a fixed monetary quantity or a percentile of the financial account. In yet another version, the user may transactionally link one portion of a given financial account to one followed account's financial account, and another portion of that same given financial account to another followed account's financial account.

In one aspect, when a user's financial account is transactionally linked with a second account through the action of following that second account, the user's financial account is acted upon or manipulated by the platform so as to duplicate either wholly or in some proportion thereof one or more transactions observed or executed in or by one or more financial accounts transactionally linked with the second account. In one embodiment, the acts or manipulations on the user's financial account are only virtual—that is, the underlying financial quality and quantity of the account remain the same, but appear in the user interface to be adjusted based on those acts or manipulations and the market effects that follow. In this embodiment, the performance history and/or financial account that display these virtual changes are identified to the user and/or other users as virtual. In another embodiment, a user can identify whether a given association is to be actual (i.e., the acts and manipulations affect the underlying financial quantity and quality of the account) or virtual. In yet another embodiment, a user can simulateously associated actually and virtually, such that the association is the same or different quantitatively, enabling that user to observe how the user's performance history would have been affected if the user had commanded a different (the virtual) association. In a further embodiment, the user can implement multiple distinct virtual associations and/or an actual association. Each of these multiple distinct virtual associations may be automatically titled by the platform by a combination of date and/or the kind of transaction and/or the name of the leader whose transaction is followed, and/or may be customly named by the user

10. Limits to Transactional Linking

In one embodiment, the platform will prompt the user that a transaction has been executed in or through a followed account's financial account; the user may accept the transaction, in which case the transaction is executed by the platform in the user's own financial account, or may reject the transaction, in which case the platform does not execute the transaction. In one version, the prompt will be provided by the platform if a “limit”, described below, is imposed by the user.

In another embodiment, the user may impose a limit on transactions executed by the platform. This limit may be a monetary limit, such that if a given transaction exceeds an amount identified by the user, the transaction will not be executed in or through the user's own financial account. The amount identified may be a fixed amount, such as $5000, or it may be a percentile of the financial account, such as 33%. In another version, a limit may constitute a category of investment, such as species of security or industry categories, rather than a monetary amount.

The versions and embodiments of the limit, as described above, are negative—that is, a transaction is blocked or a prompt is triggered if a condition is met. In another version, the limit may be positive—that is, transactions are only executed if a condition is met. In this kind of limit, the condition may be monetary ranges—such as, between $0 and $500, or 0% and 33%—or they may be security species or industry categories.

The limits may be imposed in reference to any transactions made in or through followed account's financial accounts, or only in reference to one or more selected leader or index accounts.

It should be understood that one or more limits may be simultaneously applied to the same financial account or portion thereof. These one or more limits may be saved as a “limit regime” and may be therefore “loaded” onto one or more other financial accounts or portions thereof.

In one embodiment, the user can select, indicate, or mandate a minimum number of leaders and/or indexes that are executing a given trade type and/or quantity before the platform is permitted to execute the mirrored transaction for one or more of the user's financial accounts. In another embodiment, the user may select one or more particular leaders and/or indexes, and mandate that the platform may only execute a mirrored trade only if an indicated number of the one or more particular leaders and/or indexes have also executed the transaction.

In one embodiment, the platform may receive a request from the user to transactionally link the financial account established and operated by the platform with a followed account's financial account. The financial account contemplated in this embodiment refers does not refer to a financial account hosted, stored, or otherwise handled by a third party (outside financial institution, such a a bank), but rather a financial account under the dominion of the owners of the platform.

11. Platform Receives Payment

In one aspect, users are required to pay a fee to the operators of the platform. In one embodiment, the users pay a fixed amount per an interval of time (month, year, etc). In another embodiment, the users pay a monetary percentile of the amount from their financial accounts asset value that they have transactionally linked with one or more leaders and/or indexes. In yet another embodiment, users pay a monetary percentage of gains earned from transactionally linking their financial accounts with one or more leaders and/or indexes. In yet another embodiment, users pay a fee that is in a combination of a fixed amount, a monetary percentage of the amount from their financial accounts asset value, and a monetary percentage of gains earned from transactionally linking their financial accounts with one or more leaders and/or indexes.

12. Leaders Receive Payment

In one aspect, the leader receives payment from the operators of the platform. In one embodiment, payment is deposited directly into the leader's financial account; this financial account may be one that is associated with the leader's account for the platform, or in a seperate designated financial account. In another embodiment, payment is send by check or other means.

In one embodiment, payment is proportionate to the number of users following the leader. In another embodiment, payment is a percentile of the monetary value of financial accounts asset values of users following the leader. In another embodiment, payment is a percentile of the monetary value of gains earned by users folowing the leader. In another embodiment, payment is a combination of a percentile of the monetary value of financial accounts asset values of users and a percentile of the monetary value of gains earned by users folowing the leader. In one embodiment, payment to a leader occurs simultaneously with and as a percentage of the fee paid by the user each time a transaction is executed and/or gain is made in or through a user's financial account as a result of a transactional linking with that leader's financial account.

When a leader is not directly followed by a user but is instead a part of an index of leaders that is being followed, there are several payment options. The total payment obtained by the platform may be divided into a portion retained by the operators of the platform, and a portion to be divided by the leaders in the index. The latter portion may be divided equally between the leaders. It may be divided based on a pre-established set of percentiles, such that the leader with the greatest financial account size receives the first percentile, the leader with the second greatest financial account ize receives the second percentile, etc. Or it may divided such that the leader with the greatest performance return for a period receives the first percentile, the leader with the second greatest return receives the second percentile, etc.

13. User Interface, Generally.

In one aspect, the user interface of the platform comprises a frame. This frame is a graphical display that may surround or graphically contextualize other components of the user interface.

In one embodiment, the frame comprises a search field. This platform may receive search queries entered by the user into this search field, and then display a list of relevant results. If a given result is selected by the user, the platform will display a graphical representation of one or more portions of data from the database, including a user profile.

In one embodiment, the frame comprises a settings or options tab or menu, which may provide one or more general “privacy levels” which impact the visibility of one or more articles of information and/or categories thereof.

### BRIEF DESCRIPTION OF THE DRAWINGS

FIG. 1 feautures an exemplary software logic and process flowchart.

FIG. 2 feautures an exemplary software logic and process flowchart.

FIG. 3 feautures an exemplary software logic and process flowchart.

FIG. 4 feautures an exemplary software logic and process flowchart.

FIG. 5 feautures an exemplary software logic and process flowchart.

FIG. 6 feautures an exemplary software logic and process flowchart.

FIG. 7 feautures an exemplary software logic and process flowchart.

FIG. 8 feautures an exemplary software logic and process flowchart.

FIG. 9 feautures an exemplary software logic and process flowchart.

FIG. 10 feautures an exemplary software logic and process flowchart.

FIG. 11 feautures an exemplary software logic and process flowchart.

FIG. 12 feautures an exemplary software logic and process flowchart.

FIG. 13 feautures an exemplary software logic and process flowchart.

FIG. 14 feautures an exemplary software logic and process flowchart.

FIG. 15 feautures an exemplary hardware setup.

### DETAILED DESCRIPTION

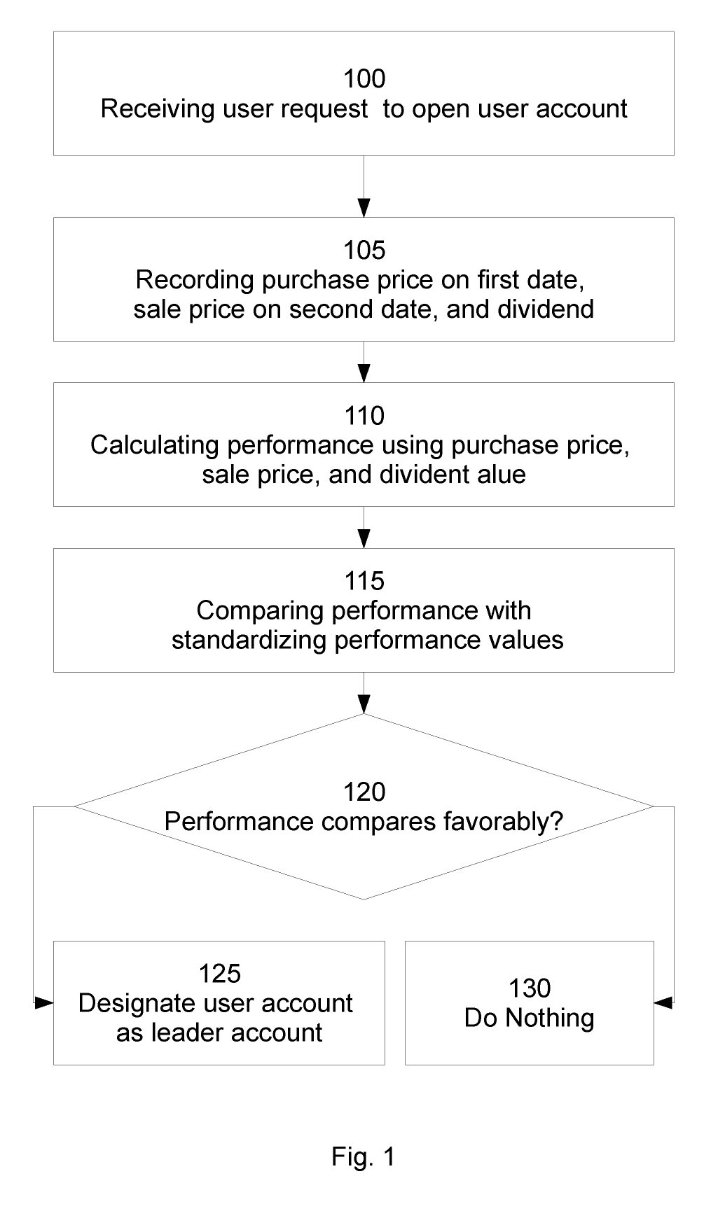

As shown in FIG. 1, the process includes the steps of 100 receiving a request from a user to open a user account. This request may be initiated by the user through a prompt appearing on the user interface. Then next step is 105 recording at least one purchase price for a finanical product purchased by the user through a brokerage on a first date, at least one sale price for the financial product sold by the user through a brokerage on a second date, and a dividend value derived from the financial product during a time period between the first date and the second date. These steps may occur in any order, and the recording may happen simultaneous to the event or after it has already transpired. In some situations one or more of them may not apply. For example, if there is a particular financial product does not feature a dividend, no divident is required. The next step is 110 calculating performance using the at least one purchase price, the at least one sale price, the first date, the second date, and the dividend value. This performance may be associated with the performance value with the user account. The next step is 115 comparing performance with one or more standardizing performance values. A standardizing performance value is a number or notation calulated for the purpose of taking multiple relevant values into account for the purpose of comparing performance values across user accounts and/or transactions. The next step is to determine 120 whether performance compares favorably with the one or more standardizing performance value. If so, the next step is 125 designating the user account as a leader account. Otherwise, the next step is to 130 do nothing.

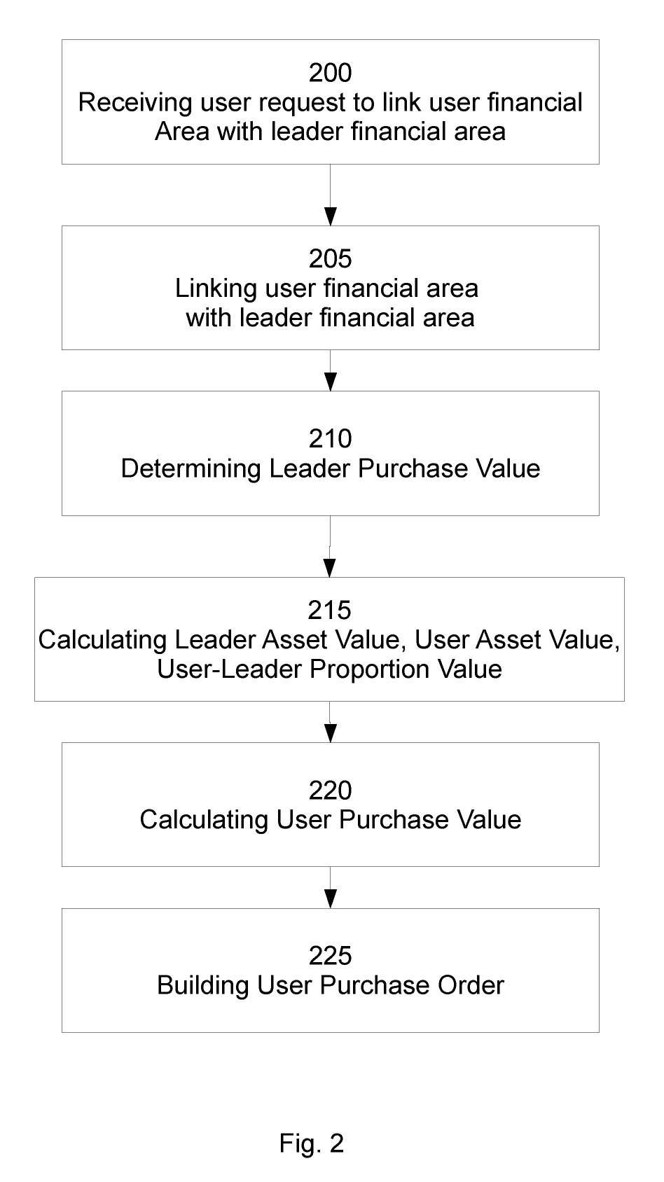

As shown in FIG. 2, the process may include the step of 200 receiving a user request to link a user financial activity area with a leader financial activity area. A financial activity area may comprise a single financial account or multiple financial accounts belonging to the same user. The financial accounts may be created by the system or may be outside accounts with brokerage agencies. A financial activity area may also comprise a part or portion of a single financial account. A user financial activity area and a user financial activity area are substantially the same except that the latter belongs to a user who has been designated as a leader on account of that user's performance history, although a user may also be designated as a leader as a matter of discretion decided by the operators of the system.

The process also includes the step of 205 linking the user financial activity area with the leader financial activity area. This linkage will effectually allow for the mimicking or duplication of transactions executed by the leader, to be executed for the user. It is conceivable that a user may link a part or a whole of a given user financial activity area or areas to a part or whole of a given leader financial activity area or areas. The next step 210 is determining a leader purchase value, which is a variable or function that expresses the kind and quantity of financial products purchased by a leader or for a leader financial account. The next few steps include 215 calculating a leader asset value, which may amount to an identification of the monetary value of one or more transactions or changes in a financial account that result therefrom, using financial information associated with the leader account, calculating a user asset value using financial information associated with the user account, which may be the same as a leader asset value except that it is calculated for or from accounts that were not designated as leaders, and calculating a user-leader proportion value using the user asset value and the leader asset value, which is a ratio or comparison of the asset values. These three steps may happen in any order. For example, calculating the user asset value may occur periodically, or in response to the indication of a leader purchase value. Similarly, calculating the leader asset value may only be necessary if the leader is linked to a user and a leader purchase value or an indication thereof occurs, is executed, or is received. Finally, the user-leader proportion value may be calculated periodically or only upon the occurence, execution, or receiving of the leader purchase value or an indication thereof. The next steps are 220 calculating a user purchase value, which is a type or amount of purchase, using the leader purchase value and the user-leader proportion value, and 225 building a user purchase order using the user purchase value. This user purchase order may contain information identifying the kind and quantity of financial products to purchase for or on behalf of the user.

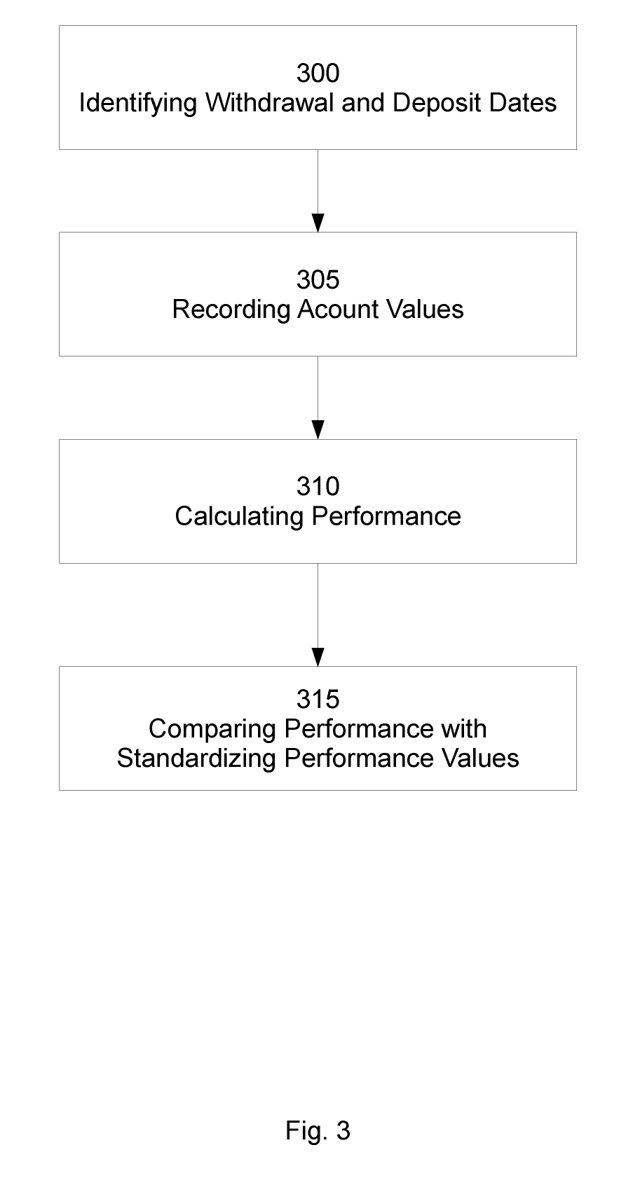

As shown in FIG. 3, the process includes the steps of 300 identifying withdrawal and deposit dates for a financial account associated with the user account, and 305 recording account values for time periods between withdrawal/deposit dates. In this manner, the account history is divided into periods, so that the return on the investments can be calculated without being corrupted by withdrawals or deposits. The withdrawals and deposits will be included in the initial account value for each period that they precede, and will not be included for each end account value that they follow.

The process also includes the step of 310 calculating performance using the account values. This calculation may be feature the returns for each period, calculated as [(end value−initial value)/initial value]; total return may be calculated as [(1+return1)×(1+return2) . . . (1+returnN)]−1.

The process next includes the step of 315 comparing performance with one or more standardizing performance values. It is conceivable that each performance will be compared to a single standardizing performance value that may be discretionally decided by the operators of the platform, or may be calculated by adding, averaging, or otherwise taking into account the performance values of all other users. Alternatively, performance value may be compared iteratively and individually to the performance value of other users. Steps 300-315 may be used in place of steps 105-115.

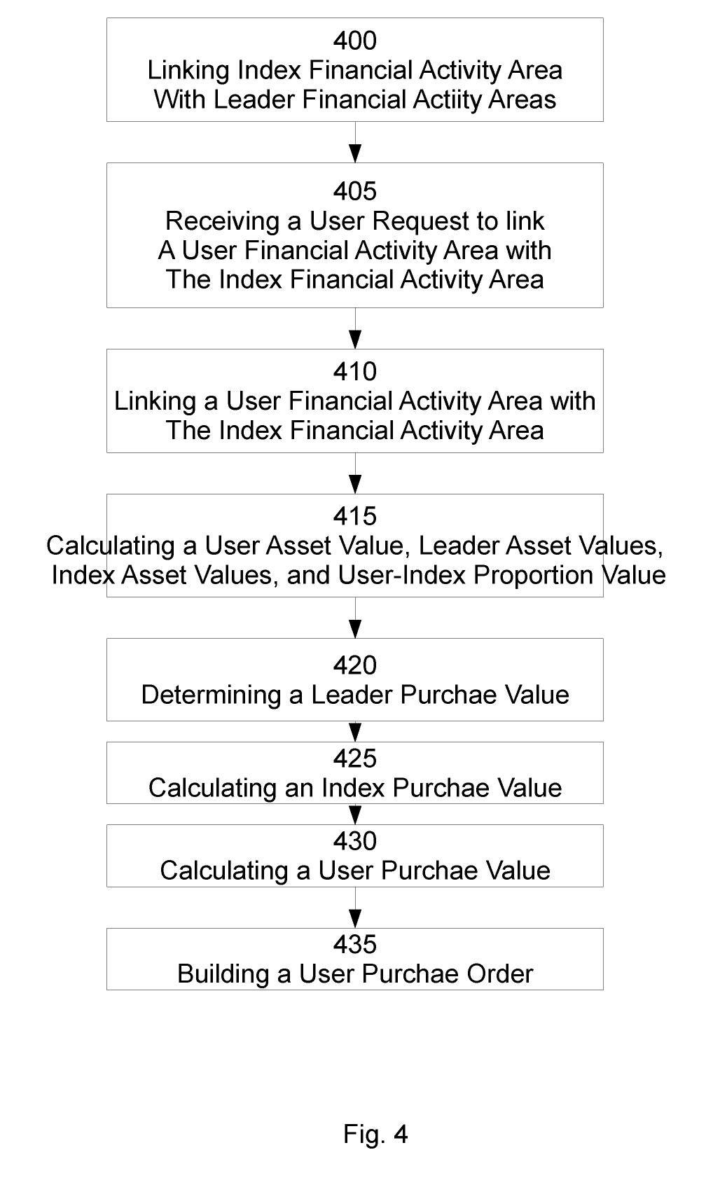

FIG. 4 features a process including the step of 400 linking an index financial activity area with leader financial activity areas. The index financial activity can be understood to be a duplication of the leader financial activity, or a representation thereof. It may operate as a virtual account, which may then be mimicked in whole or in part by users. The process also includes the steps of 405 receiving a user request to link a user financial activity area to the index financial activity area, and 410 linking the user financial activity area with the index financial activity area. By linking the user financial activity area to the index financial activity area, the system will execute trades for the user financial activity area to mimick those made or represented by the index financial activity area. Anoter step is 415 calculating a user asset value using financial information associated with the user account, calculating leader asset values using financial information associated with leader accounts, calculating an index asset value by summing leader asset values, and calculating a user-index proportion value using the user asset value and the index asset value. These steps assure the proportionality of the mimicking. The asset values generally include the total size of the account. The process also includes 420 determining a leader purchase value using a leader financial activity area linked to index activity, 425 calculating an index purchase value using the leader purchase value, 430 calculating a user purchase value using the index purchase value and the user-index proportion value, and 435 building a user purchase order using the user purchase value.

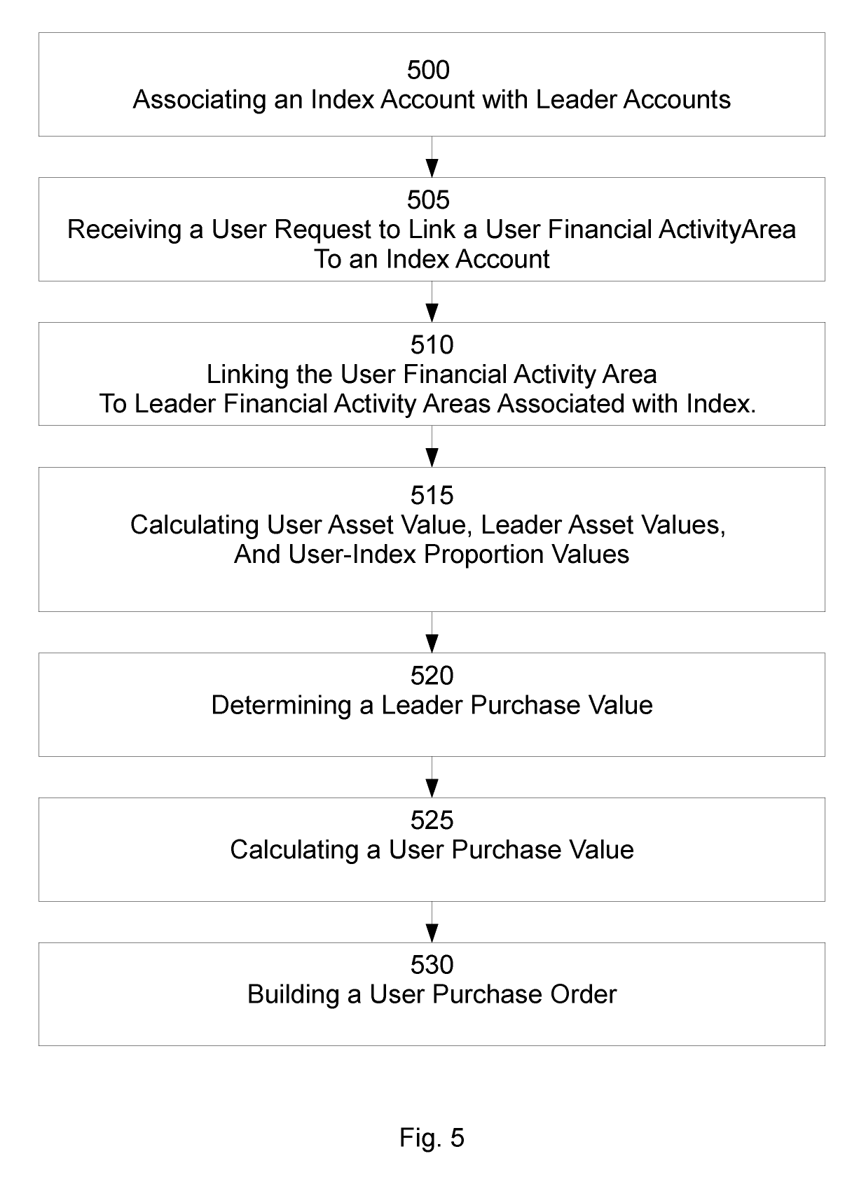

FIG. 5 features a process including the steps of 500 associating an index account with one or more leader accounts, 505 receiving a user request to link a user financial activity area to an index account, and 510 linking the user financial activity area to leader financial activity areas associated with the one or more leader accounts associated with the index account. This can be distinguished from FIG. 4 in that here, the user is directly linking to the leader financial activity areas, and the index account merely serves to facilitate the selection of the leaders. The process also includes the steps of 515 calculating a user asset value using financial information associated with the user account, calculating leader asset values using financial information associated with each of the one or more leader accounts, calculating a user-index proportion value using the user asset value and the leader asset values. This is also similar to the steps in FIG. 4, except that the user-index proportion value is calculated using the leader asset values directly.

Additional steps include 520 determining a leader purchase value using the leader financial activity area, 525 calculating a user purchase value using the leader purchase value and the user-index proportion value, 530 building a user purchase order using the user purchase value.

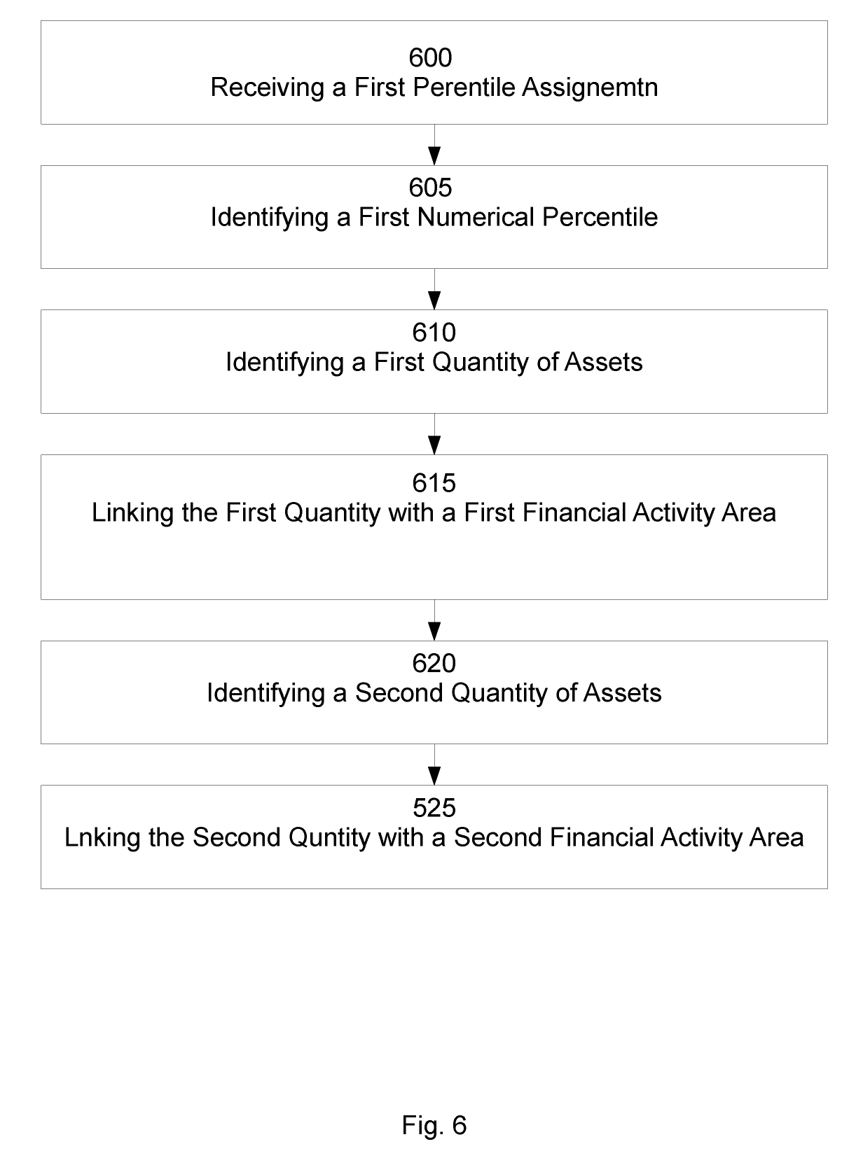

FIG. 6 features a process including the steps of 600 receiving a first percentile assignment from a user, 605 identifying a first numerical percentile using the first percentile assignment, and 610 identifying a first quantity of assets in a user financial activity area using the first numerical percentile and 615 linking the first quantity with a first financial activity area. A percentile assignment is a percentage entered by and received from the user, and a numerical percentile is the percentage as identified by the system as a particular number after accounting for formatting. These steps permit a user to divide an account into sectors, so as to apportion strategically and diversify the investments through following separate leaders or indexes. Accordingly, the process also includes the step of 620 identifying a second quantity of assets in the user financial activity area and 625 linking the second quantity with a second financial activity area.

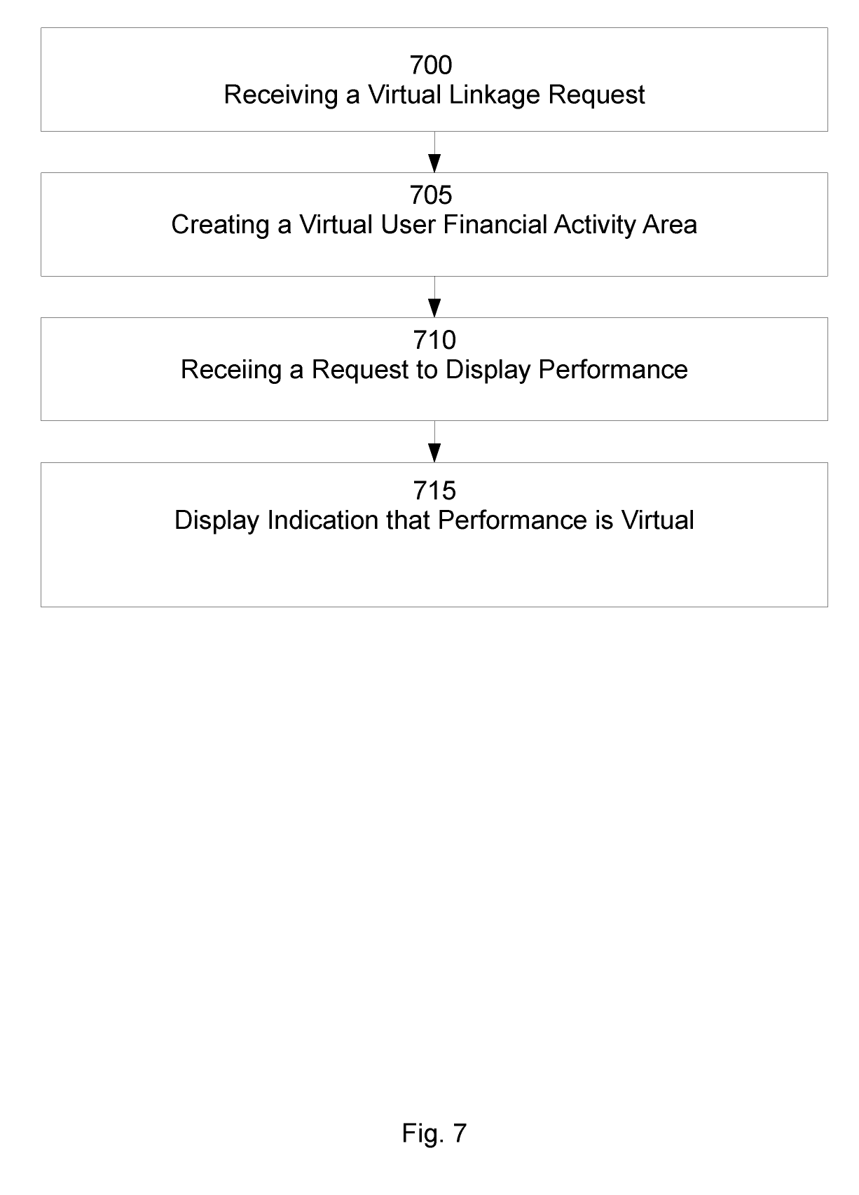

FIG. 7 features a process including the steps of 700 receiving a virtual linkage request to virtually link the user financial activity area with a financial activity area and 705 creating a virtual user financial activity area with a quantitative equivalence to the user financial activity area, the quantitative equivalence being determined at the time of the virtual linkage request. This permits a user to follow how a particular investment approach would have panned out had the user executed that approach, but without the risk of actually executing it. The process also includes the step of 710 upon receiving a request to display a representation of the performance value associated with the virtual user financial activity area, 715 display an indication that the performance value is virtual. This helps the user distinguish between the virtual and actual investments.

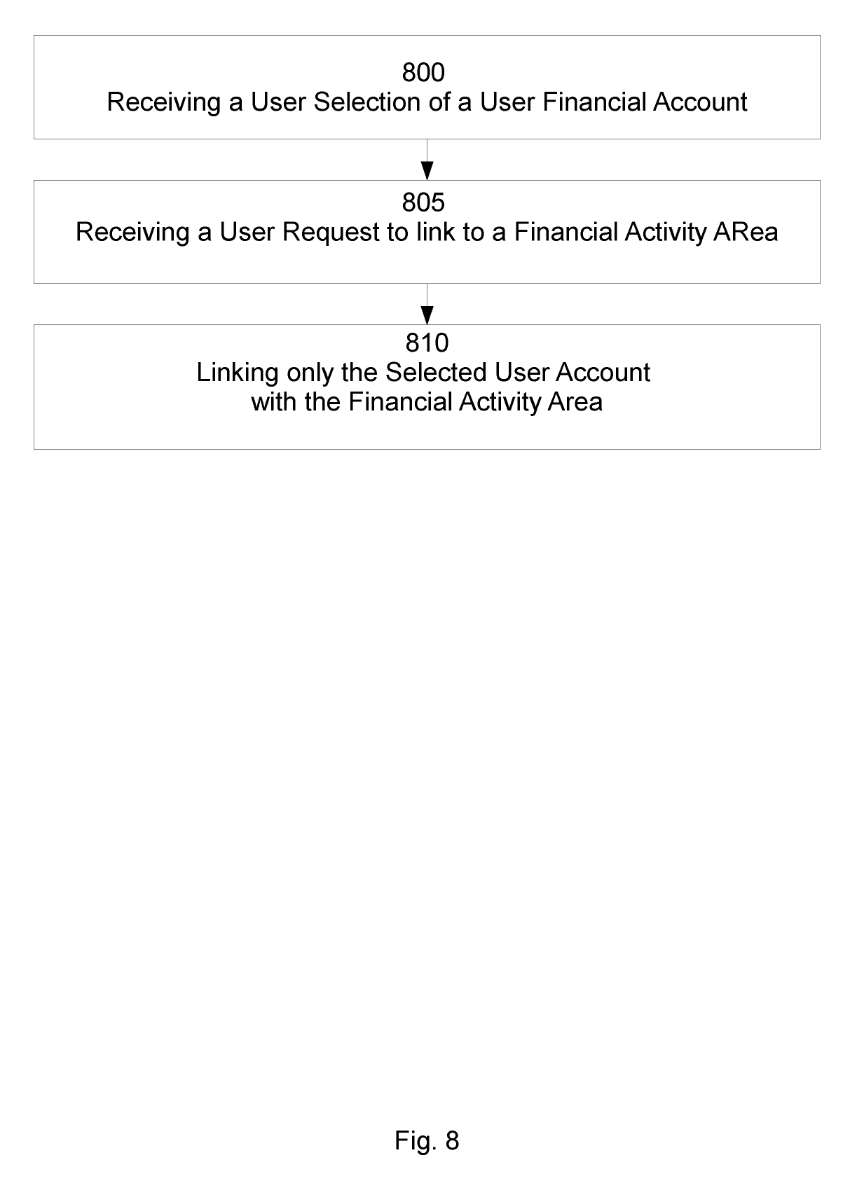

FIG. 8 features a process including the steps of 800 receiving a user selection of a user financial account from the user financial activity area that comprises at least two user financial accounts, and 810 linking only the selected user financial account with the financial activity area. Here, the user can select which of the user's one or more financial accounts will be linked.

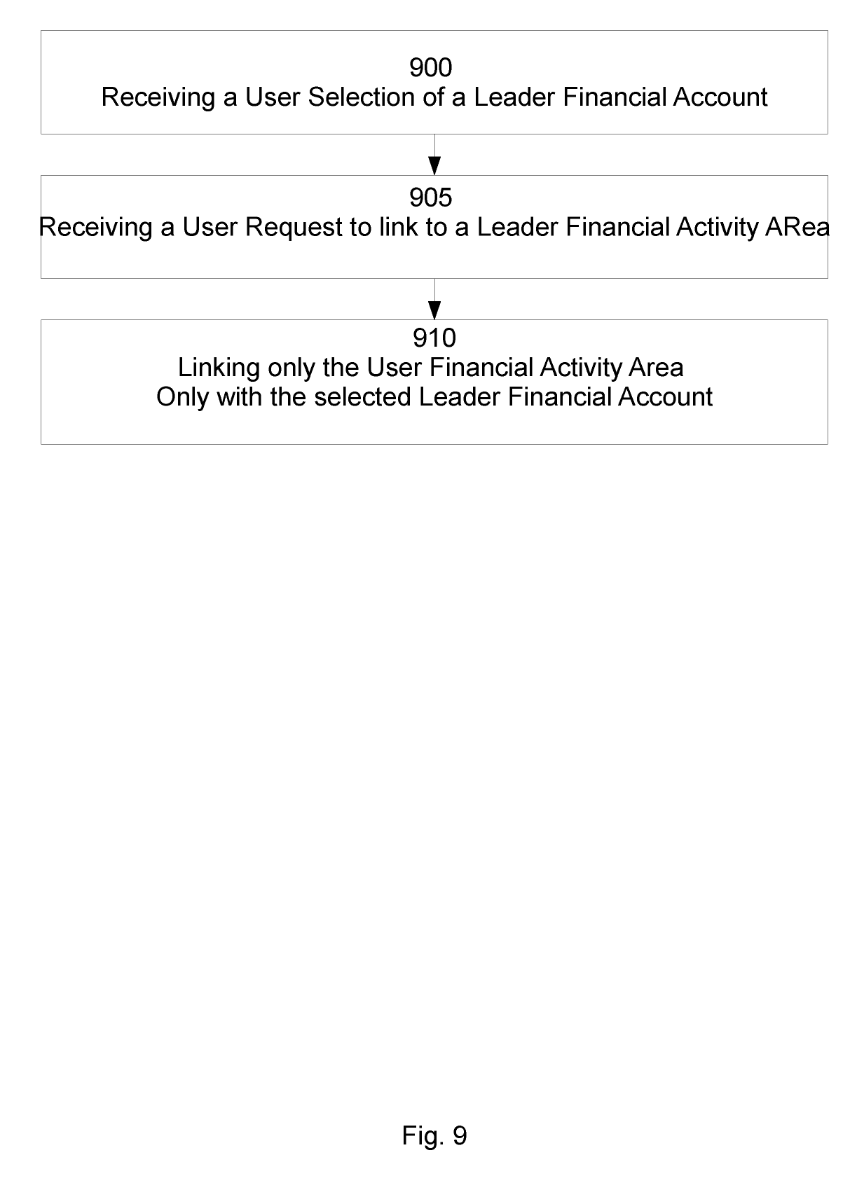

FIG. 9 features a process including the steps of 900 receiving a user selection of a leader financial account from a leader financial activity area that comprises at least two leader financial activity accounts, 905 receiving a user request to link a Leader Financial Activity Area, and 910linking the user financial activity area with only the selected leader financial account.

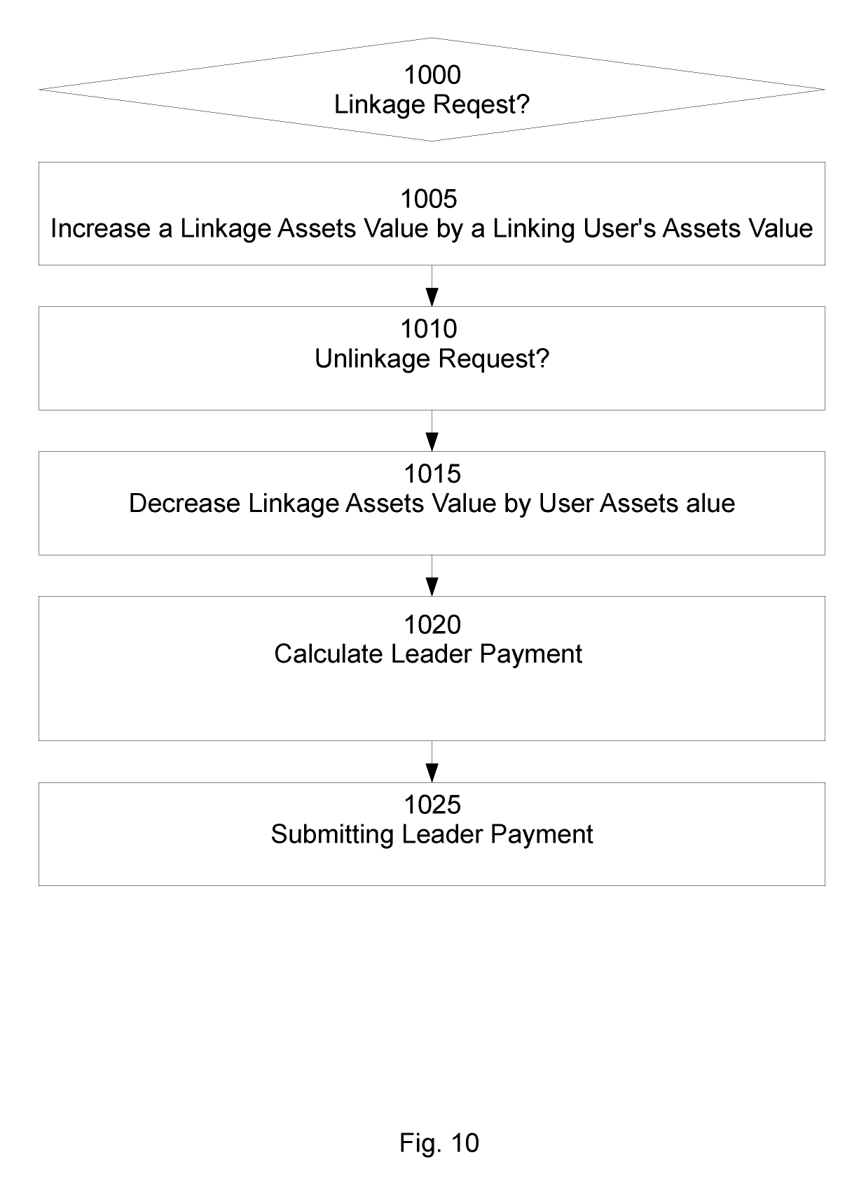

FIG. 10 features a process including the steps of 1000 determining whether a linkage request has been received, 1005 increasing a linkage assets value by linking a user's assets value by the linking user's assets value, 1010, determining whether an unlinkage request has been received, and if so, 1015, decreasing the linkage assets value by the user's assets value, 1020, calculating a user fee to be paid by the user using the user asset value, and 1025 submitting the leader payment.

Other steps include calculating a user fee to be paid by the user using the user asset value, and receiving the user fee from the user. Additional steps include calculating a user fee to be paid by the user using profit derived from a user financial activity area that has been linked to a leader financial activity area managed by a leader, and receiving the user fee from the user. Yet additional steps may include calculating a user fee based on a reocurring period of use. This reoccurring period may be monthly or yearly, and operate as a subscription. Still further steps may include calculating a user fee to be paid by the user using the number of linkages between the user financial activity area and the financial activity areas. Each time a given user links to a leader, a linkage value associated with that user increases. It is conceivable that the user fees discussed in FIGS. 10-13 can be combined.

FIG. 10 features a process including the steps of 1000 if a linkage request to a leader financial activity area is received from the user, 1005 increasing a linkage assets value by the user asset value, 1010 if an unlinkage request is received from the user, 1015 decreasing the linkage assets value by the user asset value. 1020 calculating a leader payment using the linkage assets value, and 1025 submitting the leader payment to a leader financial activity area.

The process may include the steps of associating a leader financial activity area to an index financial activity area only if they have a matching industry value.

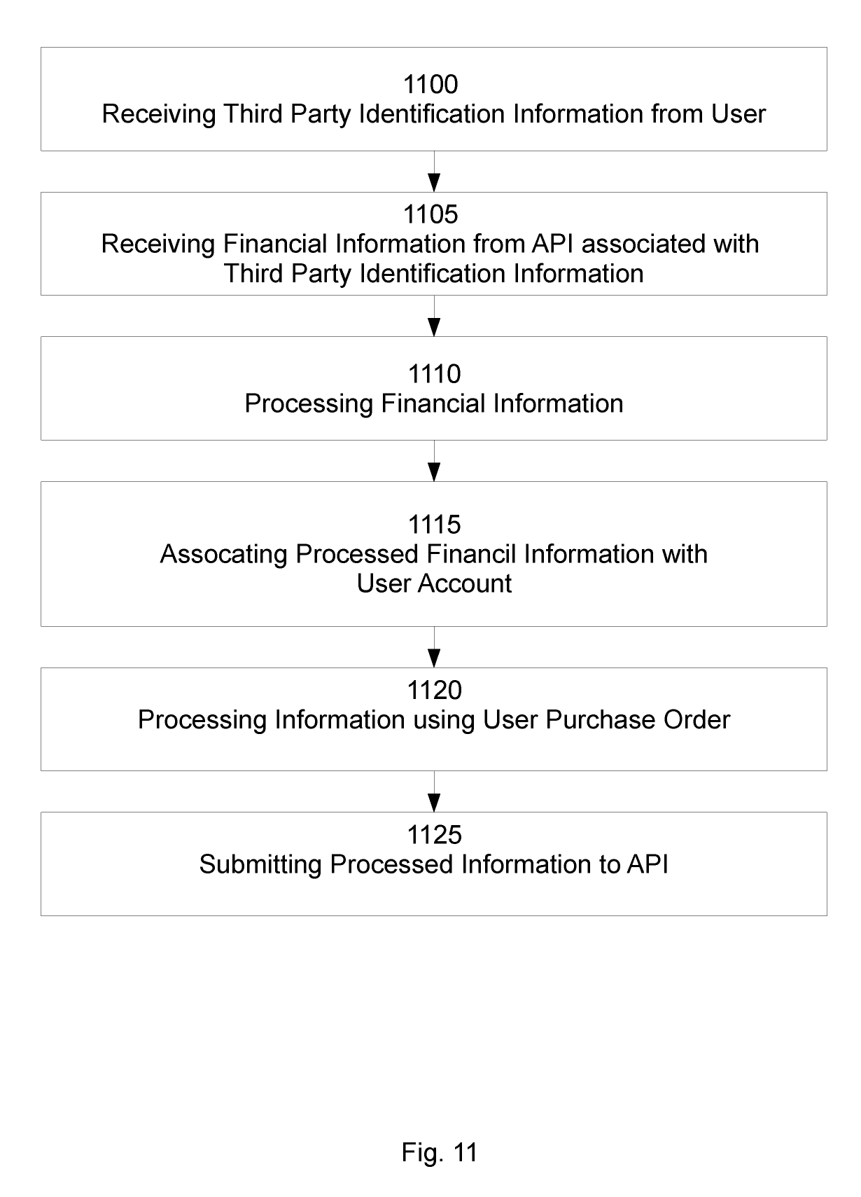

FIG. 11 features a process including the steps of 1100 receiving third party identification information from the user, 1105 receiving financial information from an API associated with the third party identification information, 1110 processing at least some of the financial information, 1115 associating at least some of the processed financial information with the user account, 1120 processing information using the user purchase order, and 1125 submitting the processed information to the API. The third party identification information may comprise a url enabling the system to access the third party online. Other information may include a username and password provided by the user, enabling the system to log in or bypass any necessary prompts that secure the user's financial information. The financial information may include an overview of the user's accounts with the third party, including the purchasing and sale and the dates thereof of financial products, stocks, bonds, etc.

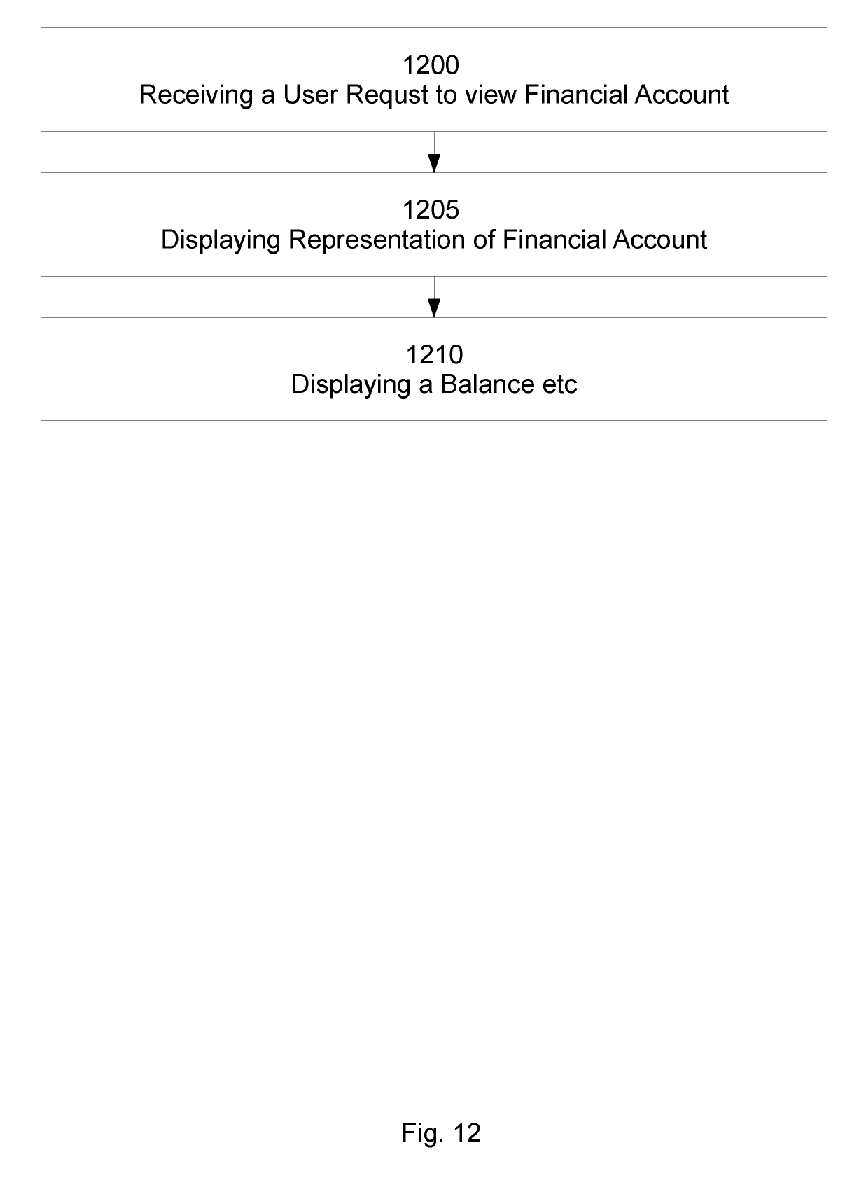

FIG. 12 features a process including the steps of 1200 receiving a user request to view at least one financial account associated with the user account, 1205 displaying a represenation of the at least one financial account, and 1210 displaying a balance and at least a most recent transaction for each of the at least one financial accounts. The display may comprise a list, or a set of tiles with parameters of the financial account displayed adjacent to each item.

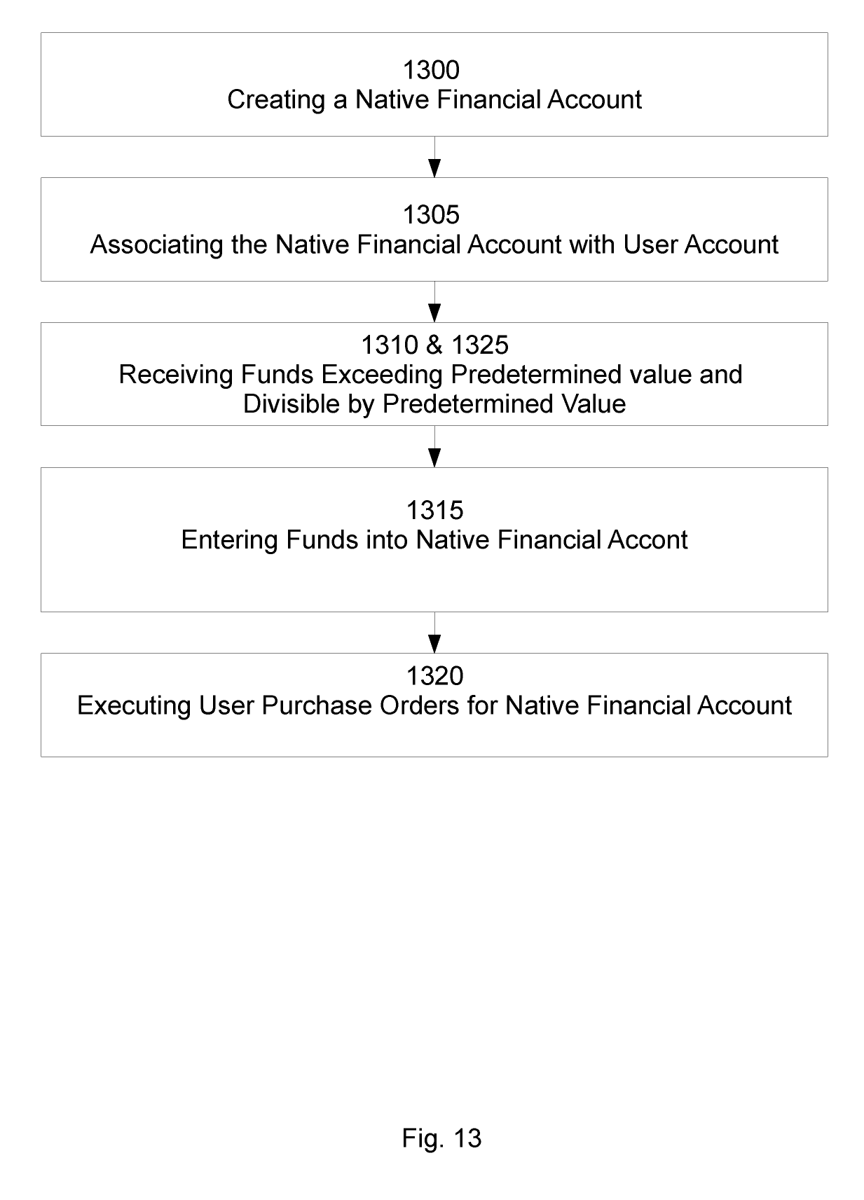

FIG. 13 features a process including the steps of 1300 creating a native financial account and 1305 associating the first native financial account with the first user account 1310 only receiving funds exceeding a predetermined value, 1315 entering the funds into the native financial account, and 1320 executing the user purchase order for the native financial account. The process may also 1325 only receiving funds divisible by a predetermined value.

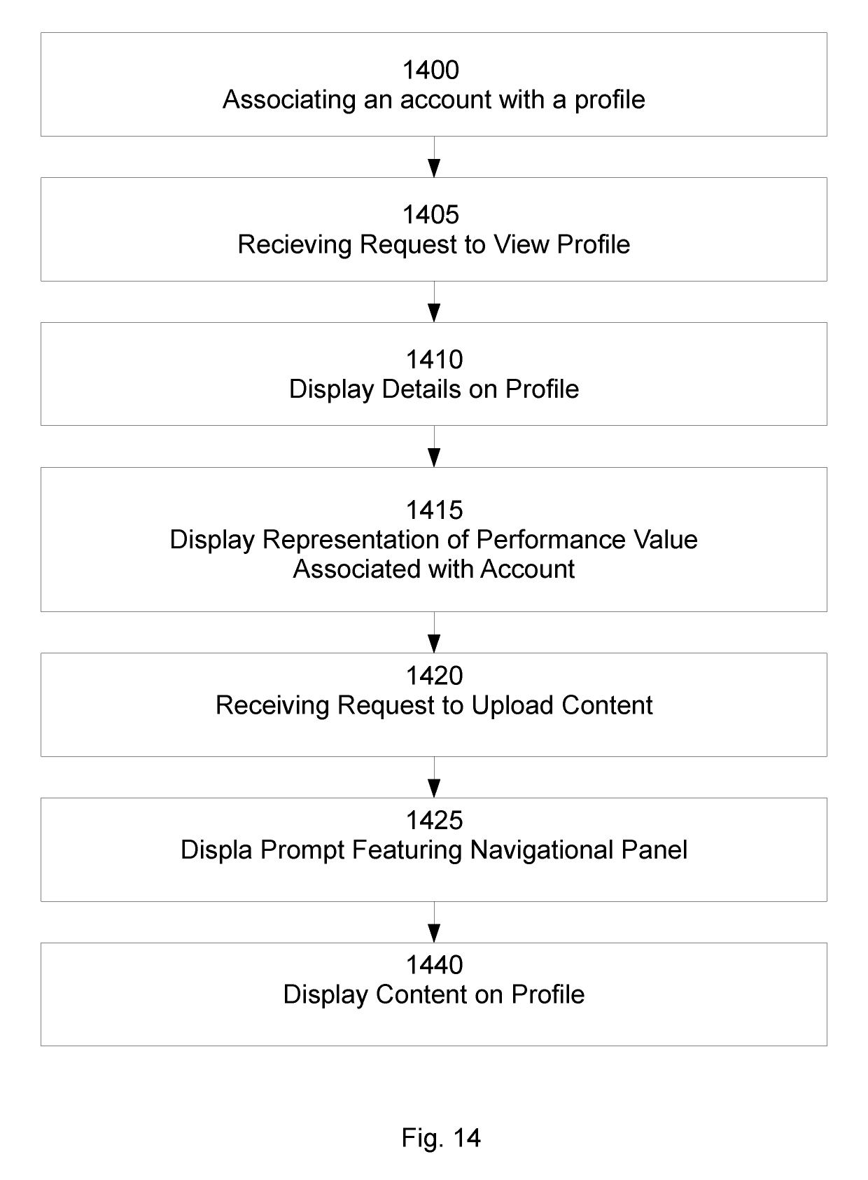

FIG. 14 features a process including the steps of 1400 associating an account with a profile, 1405 upon receiving a user request to view the profile, 1410 display one or more details associated with the account on a profile page, 1415 display a representation of the performance value associated with the account on the profile page. The process may also include the steps of 1420 receiving a user request to upload a content article 1425 displaying a prompt featuring a navigational panel 1430 receiving a location of the content article, 1435 receiving data containing the content article, and 1440 displaying the content article upon receiving a user request to view the user profile.

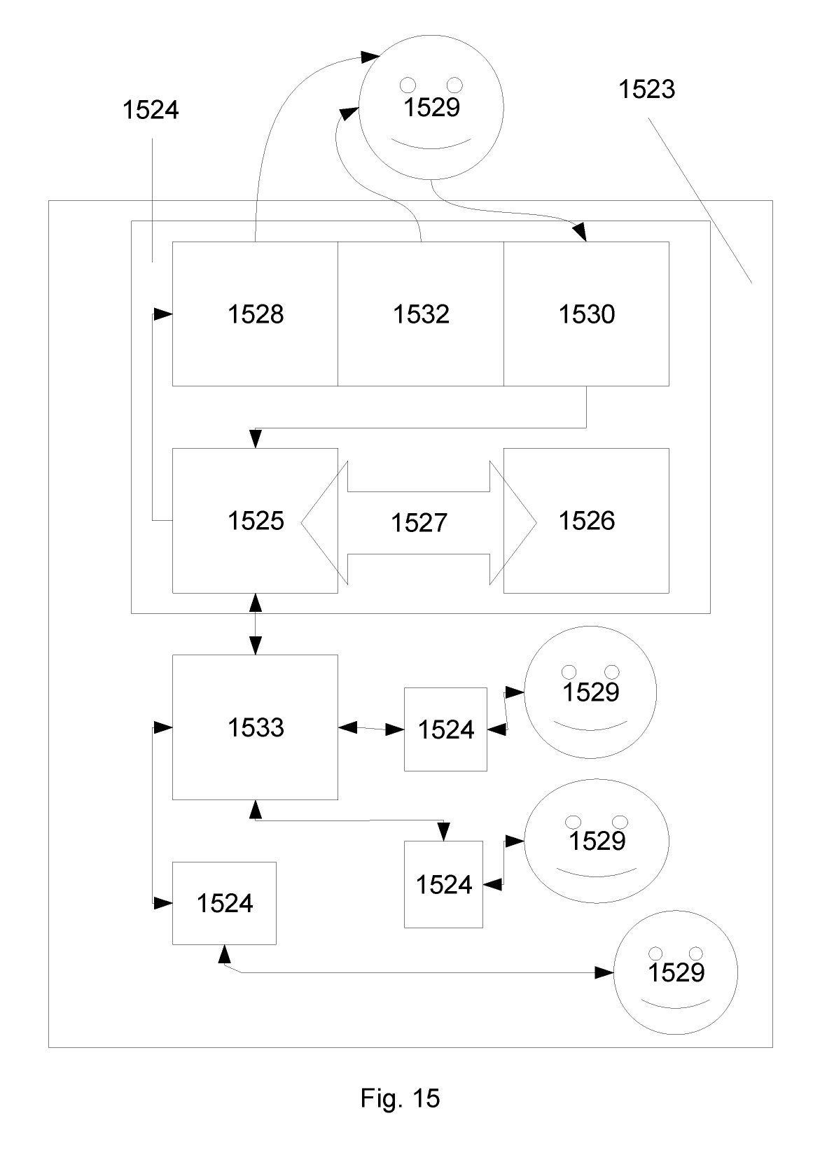

As shown in FIG. 15, a computer system 1523 for performing the embodiments described herein may comprise one or more programmed computers 1524. Each programmed computer may comprise a processor 1525 engaged with a computer memory 1526 to execute instructions 1527 loadable onto and then provided by the computer memory. The computer system may also comprise one or more display devices 1528 to graphically display to a user 1529 the embodiments described herein, and one or more input devices 1530 to receive selection, indication, and movement instructions from the user. The computer system may be embodied by a traditional desktop computer, a laptop, or mobile device. In yet another embodiment, the computer system accesses a network 1533, which may connect it to one or more other programmed computers and users. In yet another embodiment, computer memory 1526 may additionally comprise a database.

1. A system comprising a plurality of computers, each computer having a computer-readable storage memory, a processor, and access to a network, with at least two computers having a display device and one or more input devices, the computers programmed to:
receive a request from a user using a first set of one or more input devices to open a first user account, recording at least one purchase price for a finanical product purchased by the user through a brokerage on a first date, at least one sale price for the financial product sold by the user through a brokerage on a second date, and a dividend value derived from the financial product during a time period between the first date and the second date, calculating performance using the at least one purchase price, the at least one sale price, the first date, the second date, and the dividend value, and associating the performance value with the user account;
compare performance with one or more standardizing performance values and designate the first user account as a leader account if performance compares favorably with the one or more standardizing performance values;
receive a user request from a second user using a second set of one or more input devices to link a user financial activity area with a leader financial activity area and link the user financial activity area with the leader financial activity area; and
determine a leader purchase value, calculating a leader asset value using financial information associated with the leader account, a user asset value using financial information associated with a second user account, a user-leader proportion value using the user asset value and the leader asset value, and a user purchase value using the leader purchase value and the user-leader proportion value and building a user purchase order using the user purchase value.

2. A system comprising a plurality of computers, each computer having a computer-readable storage memory, a processor, and access to a network, with at least two computers having a display device and one or more input devices, the computers programmed to:
receive a request from a user using a first set of one or more input devices to open a first user account, identifying withdrawal/deposit dates for a financial account associated with the first user account, recording account values for time periods between withdrawal/deposit dates, calculating performance using the account values, comparing performance with one or more standardizing performance values, and designating the first user account as a leader account if performance compares favorably with the one or more standardizing performance values;
receive a user request from a second user using a second set of second set of one or more input devices to link a user financial activity area with a leader financial activity area and linking the user financial activity area with the leader financial activity area; and
determine a leader purchase value, calculating a leader asset value using financial information associated with the leader account, a user asset value using financial information associated with a second user account, a user-leader proportion value using the user asset value and the leader asset value, and a user purchase value using the leader purchase value and the user-leader proportion value and building a user purchase order using the user purchase value.

3. A system comprising a plurality of computers, each computer having a computer-readable storage memory, a processor, and access to a network, with at least two computers having a display device and one or more input devices, the computers programmed to:
receive a request from a user using a first set of one or more input devices to open a first user account, linking an index financial activity area with leader financial activity areas and receiving a user request to link a user financial activity area to the index financial activity area and the user financial activity area with the index financial activity area;
calculate a user asset value using financial information associated with a second user account, leader asset values using financial information associated with leader accounts, an index asset value by summing leader asset values, and a user-index proportion value using the user asset value and the index asset value; and
determine a leader purchase value using a leader financial activity area linked to index activity, calculating an index purchase value using the leader purchase value and a user purchase value using the index purchase value and the user-index proportion value and building a user purchase order using the user purchase value.

4. A system comprising a plurality of computers, each computer having a computer-readable storage memory, a processor, and access to a network, with at least two computers having a display device and one or more input devices, the computers programmed to:
receive a request from a user using a first set of one or more input devices to open a first user account, associating an index account with one or more leader accounts, receiving a user request to link a user financial activity area to an index financial activity area, andlinking the user financial activity area to leader financial activity areas associated with the one or more leader accounts associated with the index account; and
calculate a user asset value using financial information associated with a second user account, leader asset values using financial information associated with each of the one or more leader accounts, and a user-index proportion value using the user asset value and the leader asset values, determining a leader purchase value using the leader financial activity area, calculating a user purchase value using the leader purchase value and the user-index proportion value, and building a user purchase order using the user purchase value.

5. The system of claim 2, where each of the standardizing performance values comprise a unique performance value associated with a user account.

6. The system in claim 2, the computers additionally programmed to: calculate a standardizing performance value using performance values, each performance value associated with a distinct user account.

7. The system in claim 2, the computers additionally programmed to:
receive a first percentile assignment from a user, identifying a first numerical percentile using the first percentile assignment, a first quantity of assets in a user financial activity area using the first numerical percentile and linking the first quantity with a first financial activity area, and a second quantity of assets in the user financial activity area and linking the second quantity with a second financial activity area.

8. The system in claim 2, the computers additionally programmed to:
receive a virtual linkage request to virtually link the user financial activity area with a financial activity area, creating a virtual user financial activity area with a quantitative equivalence to the user financial activity area, the quantitative equivalence being determined at the time of the virtual linkage request, and upon receiving a request to display a representation of the performance value associated with the virtual user financial activity area, display an indication that the performance value is virtual.

9. The system in claim 2, the computers additionally programmed to:
receive a user request to link a user financial activity area with a financial activity area and a user selection of a user financial account from the user financial activity area that comprises at least two user financial accounts and link only the selected user financial account with the financial activity area.

10. The system in claim 2, the computers additionally programmed to:
receive a user selection of a leader financial account from a leader financial activity area that comprises at least two leader financial activity accounts and link the user financial activity area with only the selected leader financial account.

11. The system in claim 2, the computers additionally programmed to:
calculate a user fee to be paid by the user using the user asset value and receive the user fee from the user.

12. The system in claim 2, the computers additionally programmed to:
calculate a user fee to be paid by the user using profit derived from a user financial activity area that has been linked to a leader financial activity area managed by a leader and receiving the user fee from the user.

13. The system in claim 3, the computers additionally programmed to:
calculate a user fee based on a reocurring period of use.

14. The system in claim 2, the computers additionally programmed to:
calculate a user fee to be paid by the user using the number of linkages between the user financial activity area and the financial activity areas.

15. The system in claim 2, the computers additionally programmed to:
calculate a leader payment using the user fee and submitting the leader payment to a leader financial account managed by the leader.

16. The system in claim 2, the computers additionally programmed to:
if a linkage request to a leader financial activity area is received from the user, increase a linkage assets value by the user asset value;
if an unlinkage request is received from the user, decrease the linkage assets value by the user asset value; and
calculate a leader payment using the linkage assets value and submit the leader payment to a leader financial activity area.

17. The system in claim 2, the computers additionally programmed to: associate a leader financial activity area to an index financial activity area only if they have a matching industry value.

18. The system in claim 1, the computers additionally programmed to:
receive third party identification information from the user and financial information from an API associated with the third party identification information, processing at least some of the financial information, associating at least some of the processed financial information with the user account, processing information using the user purchase order, and submitting the processed information to the API.

19. The system in claim 2, the computers additionally programmed to:
receive a user request to view at least one financial account associated with the user account and display a represenation of the at least one financial account on a first display device.

20. The system in claim 2, the computers additionally programmed to:
display on a first display device a balance and at least a most recent transaction for each of the at least one financial accounts.

21. The system in claim 3, the computers additionally programmed to:
create a native financial account and associate the first native financial account with the first user account, only receiving funds exceeding a predetermined value, entering the funds into the native financial account, and executing the user purchase order for the native financial account.

22. The system in claim 21, the computers additionally programmed to:
only receive funds divisible by a predetermined value.

23. The system in claim 2, the computers additionally programmed to:
associate an account with a profile, upon receiving a user request to view the profile, display on a first display device one or more details associated with the account on a profile page, and display a representation of the performance value associated with the account on the profile page.

24. The system in claim 23, the computers additionally programmed to:
receive a user request to upload a content article, displaying on a first display device a prompt featuring a navigational panel, receiving a location of the content article, receiving data containing the content article, and displaying the content article upon receiving a user request to view the user profile.

25. The system in claim 23, the computers additionally programmed to:
associate the index account with with an index profile, and upon receiving a request to view the index profile, display on a first display device one or more details associated with the leader accounts associated with the index account.
